(19) United States
(12) Patent Application Publication
(10) Pub. No.: US 2016/0122660 A1
(43) Pub. Date: May 5, 2016

(54) SYSTEM AND METHOD FOR OPTIMIZING DILUENT RECOVERY BY A DILUENT RECOVERY UNIT

(71) Applicant: SYNCRUDE CANADA LTD. in trust for the owners of the Syncrude Project, as such owners exist now and, Fort McMurray (CA)

(72) Inventors: DANIEL BULBUC, Fort McMurray (CA); CHRISTINE ENGLER-COOPER, Sherwood Park (CA); SUJIT BHATTACHARYA, Edmonton (CA); NESMA ANSARI, Edmonton (CA); PETER CRICKMORE, Sherwood Park (CA); DAVID MUELLER, Edmonton (CA)

(21) Appl. No.: 14/931,671

(22) Filed: Nov. 3, 2015

Related U.S. Application Data
(60) Provisional application No. 62/075,023, filed on Nov. 4, 2014.

(51) Int. Cl. C10G 31/08; B01D 3/42; G05B 17/02; C10G 1/04

(52) U.S. Cl. CPC C10G 31/08; C10G 1/045; B01D 3/4211; G05B 17/02

(57) ABSTRACT

A computer-implemented method and a system for optimizing diluent recovery of a diluent recovery unit (DRU) used to recover a diluent from a tailings generated by a bitumen froth treatment process (BFTP). A regression model is determined from data points for operating conditions and corresponding diluent recovery, generated during operation of the DRU. The regression model is used to predict diluent recovery under a particular operating condition and determine a recommended value of the operating condition to achieve a target diluent recovery. The system may graphically display the regression model, the predicted diluent recovery and the recommended value, or cause the DRU to vary the operating conditions towards the recommended value.

### CROSS REFERENCE TO RELATED APPLICATIONS

The present application claims priority from U.S. Application Ser. No. 62/075,023, filed Nov. 4, 2014, which is incorporated by reference herein in its entirety.

### FIELD OF THE INVENTION

The present invention relates to recovery of diluent used in a bitumen froth treatment process, and more particularly to a method and system for optimizing diluent recovery in a diluent recovery unit (DRU) used to recover a diluent from a tailings generated by a bitumen froth treatment process (BFTP).

### BACKGROUND OF THE INVENTION

In order to recover bitumen from oil sands ore mined in Alberta, Canada, the ore is crushed and mixed with heated water, steam, and caustic (NaOH) to produce a slurry that is hydro-transported in a pipeline to a primary separation vessel (PSV). During hydro-transport, turbulent flow of the slurry in the pipeline causes bitumen films surrounding the sand particles to begin to separate, attach to entrained air bubbles, and form bitumen droplets. Air is introduced into the PSV to float the bitumen to the top of the PSV as a bitumen-rich froth. The bitumen froth is separated from the PSV, and in a process referred to as a bitumen froth treatment process (BFTP), mixed with a naphthenic or paraffinic diluent, and subjected to gravitational or centrifugal separation to separate diluted bitumen from tailings.

Conventionally, tailings produced by the BFTP are discharged into tailing ponds for long-term storage and sedimentation of the solids contained therein. Before doing so, however, it is desirable to recover as much residual diluent from the tailings. This reduces the amount of diluent that would otherwise be discharged into the environment, and thus lost from the BFTP. Even incremental gains in the rate of diluent recovery from tailings can represent significant reductions on the environmental impacts and costs of synthetic crude production at an industrial scale.

In practice, diluent recovery of a DRU may be variable and suboptimal, ranging between 60 to 90 per cent. One reason is that the DRU's performance is affected by numerous operating conditions, which interact with each other and may change over time. Rational models that attempt to relate these operating conditions tend to be complicated, computationally intensive, and specific to a particular DRU. Simplifying assumptions (e.g., that the DRU operates under equilibrium conditions, or that certain operating conditions do not affect diluent recovery can be made but at the expense of the model's accuracy or range of application. So far, these models have failed to accurately predict the behaviour of the DRU, such that optimizing the DRU's performance remains largely dependent on the skill and experience of its operator.

Accordingly, there is a need in the art for methods and systems for optimizing recovery of diluent in the BFTP process. Preferably, such methods and systems are capable of predicting the performance of a DRU in an accurate and robust manner under diverse operating conditions, and automatically controlling the operating parameters to optimize diluent recovery rates.

### SUMMARY OF THE INVENTION

The present invention is directed to a computer-implemented method and a computer-based system that can be used as a tool to optimize diluent recovery of a diluent recovery unit (DRU) used to recover a diluent from a tailings generated by a bitumen froth treatment process (BFTP). The tool uses actual data of the operating conditions and resulting diluent recovery of the DRU to determine a regression model, which is then used to predict the diluent recovery of the DRU for a given set of operating conditions. The tool may facilitate optimizing the performance of the DRU by providing information to its operator about operating conditions that result in suboptimal performance, predicting the effect of changes in operational conditions on DRU performance, and making recommendations on operational conditions required to achieve a target diluent recovery (TDR). The tool may also allow for process automation by causing control means associated with the DRU to vary the operating conditions in accordance with recommendations based on the regression model. The diluent recovery tool may be “self-training”, wherein after varying the operating conditions, the system acquires new data on the operating conditions and corresponding performance of the DRU to update the regression model.

Thus, in one aspect, the present invention provides a method for optimizing diluent recovery of a DRU used to recover a diluent from a tailings generated by a BFTP. The method is executed by a processor operatively connected to a memory storing a set of instructions, the method comprising the steps of:
(a) receiving and storing in the memory, a model data set generated during operation of the DRU, wherein the model data set comprises a plurality of data points for a plurality of operating conditions and a corresponding diluent recovery of the DRU, wherein at least one of the plurality of operating conditions exhibits variation over a range of values;
(b) based on the model data set, determining a regression model of the relationship between the plurality of operating conditions and the corresponding diluent recovery of the DRU; and
(c) receiving an input data point for the plurality of operating conditions, and in response thereto, taking a related action comprising predicting the diluent recovery of the DRU.

In one embodiment, the related action further comprises causing a display device to display a representation of the regression model in association with the input data point, and the predicted diluent recovery of the DRU.

In one embodiment, the related action further comprises determining a recommended value for at least one of the plurality of operating conditions for the predicted diluent recovery to approach a target diluent recovery (TDR), based on the regression model, and causing the display device to display a representation of the recommended value for the at least one of the plurality of operating conditions.

In one embodiment, the related action further comprises determining a recommended value for at least one of the plurality of operating conditions for the predicted diluent recovery (PDR) to approach a target diluent recovery (TDR), based on the regression model, and causing a control means associated with the DRU to vary the at least one of the plurality of operating conditions towards the recommended value. The related action may further comprise receiving a new data point for the plurality of operating conditions and a corresponding TDR of the DRU; updating the model data set by storing the new data point as one of the data points of the model data set; re-determining the regression model; re-determining the recommended value; and causing the control means to vary the at least one of the plurality of operating conditions towards the re-determined recommended value. These steps may be performed iteratively until the difference between the predicted diluent recovery (PDR) and the target diluent recovery (TDR) is below a desired value.

In embodiments of the above methods, the DRU may comprise a stripping column, and the plurality of operating conditions may comprise a flow rate of the tailings into the stripping column; a concentration of the diluent in the tailings flowing into the stripping column; a flow rate of steam into the stripping column; and a top pressure of the stripping column.

In embodiments of the above methods, the DRU may comprise a first stripping column and a second stripping column, and the plurality of operating conditions may comprise a first flow rate of the tailings into the first stripping column and a second flow rate of the tailings into the second stripping column.

In another aspect, the present invention provides a system for optimizing diluent recovery in a DRU used to recovery a diluent from a tailings generated by a BFTP. The system comprises a processor, and a memory storing a set of instructions executable by the processor to implement a method as described above.

In another aspect, the present invention provides a system used to recover a diluent from tailings generated from a BFTP. The system comprises: a DRU comprising a stripping column; a sensor means for measuring a plurality of operating conditions associated with the stripping column and a diluent recovery rate of the DRU; a control means for controlling at least one of the plurality of operating conditions; a computer comprising a processor and a memory storing a set of instructions; wherein the processor is operatively connected to the sensor means to receive a signal indicative of the plurality of operating conditions and the corresponding diluent recovery of the DRU; wherein the processor is operatively connected to the control means to cause the control means to vary at least one of the plurality of operating conditions of the DRU; and wherein the processor is responsive to the set of instructions to implement a method as described above.

In another aspect, the present invention provides a computer program product comprising a medium storing instructions readable by a processor to cause the processor to execute a method as described above.

Other features will become apparent from the following detailed description. It should be understood, however, that the detailed description and the specific embodiments, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Referring to the drawings wherein like reference numerals indicate similar parts throughout the several views, several aspects of the present invention are illustrated by way of example, and not by way of limitation, in detail in the following figures. It is understood that the drawings provided herein are for illustration purposes only and are not necessarily drawn to scale.

FIG. 1 is a schematic depiction of one embodiment of the system of the present invention.

FIG. 2 is a functional block diagram of one embodiment of the computer of the present invention.

FIG. 3. is a flow chart of the steps of one embodiment of the method of the present invention.

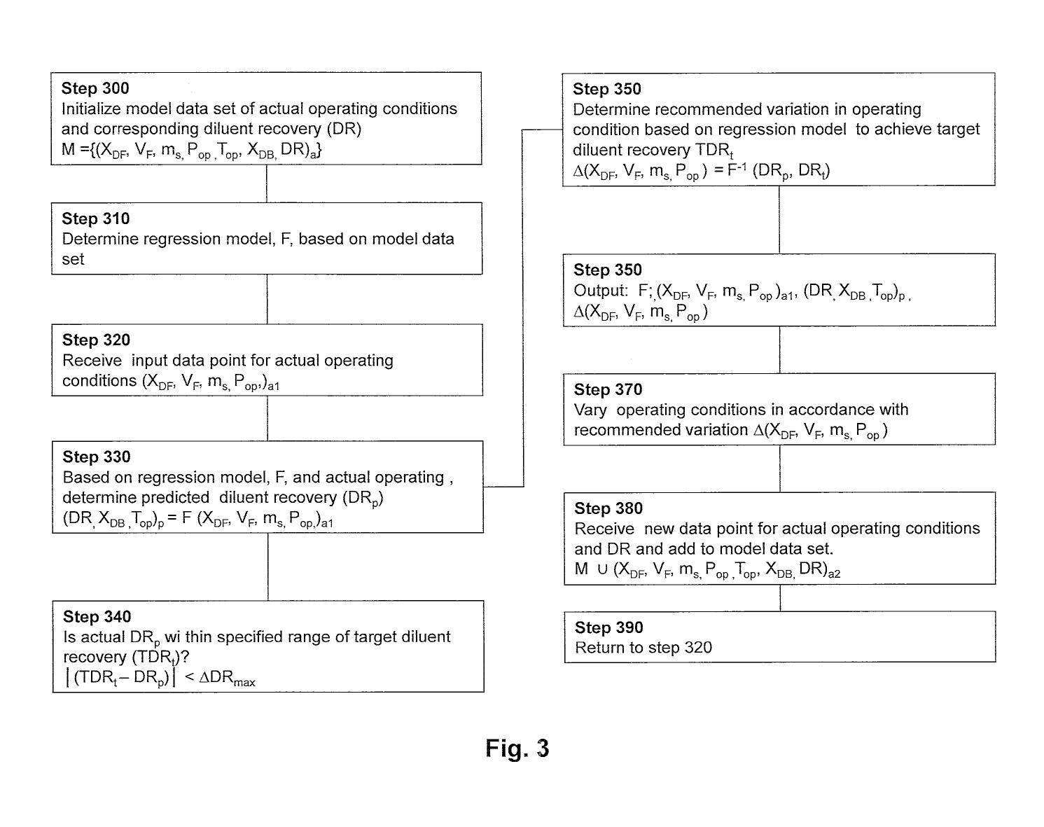

FIG. 4 is a schematic representation of the input and output of one embodiment the system of the present invention.

FIG. 5 is a graphical user interface displaying the output produced by one embodiment of the system of the present invention.

### DESCRIPTION OF THE PREFERRED EMBODIMENT

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

The present invention relates generally to a method and a system for optimizing diluent recovery of a diluent recovery unit (DRU) used to recover a diluent from a tailings generated by a bitumen froth treatment process (BFTP).

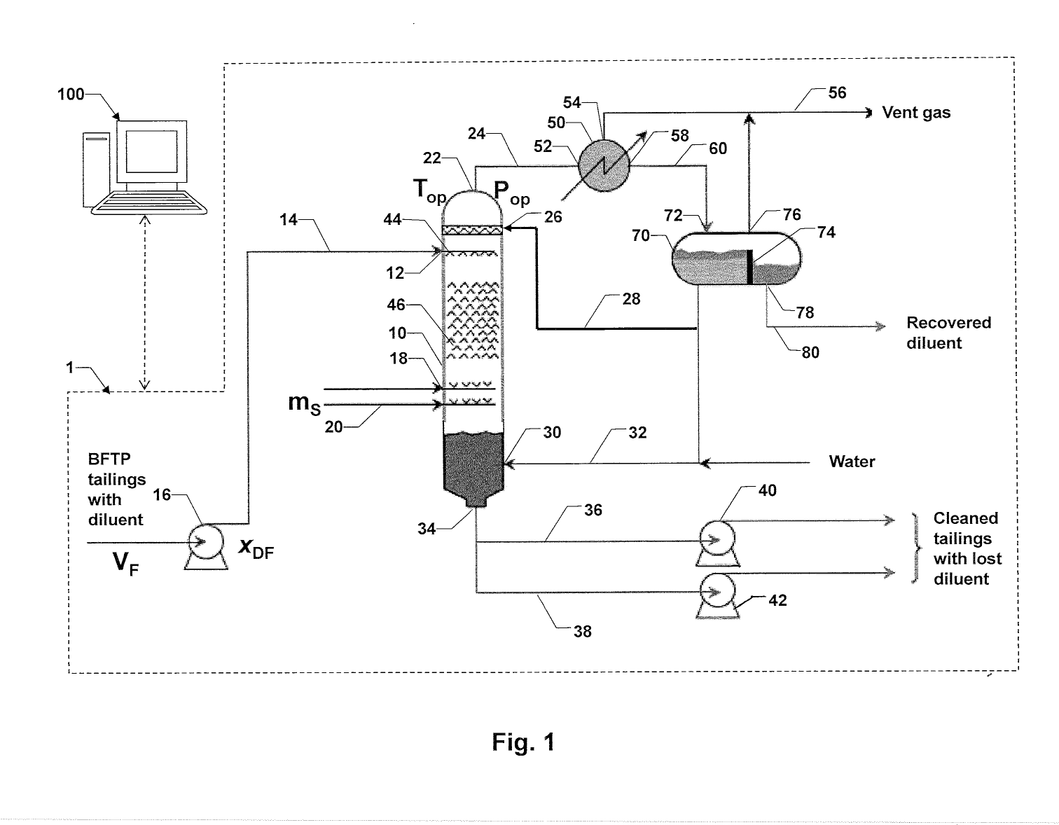

As used herein, a “diluent recovery unit” or “DRU” means a system for stripping diluent from BFTP tailings. FIG. 1 provides a schematic depiction of one embodiment of a DRU 1 in the prior art. It will be understood that this embodiment of the DRU 1 is provided for illustrative purposes and is not limiting of the present invention. In general, the DRU 1 comprises a steam stripping column 10, a cooler condenser 50, and a decanter 70. The column 10 has a BFTP tailings inlet 12 connected to a feed line 14 having a pump 16, a steam inlet 18 connected to one or more steam feed lines 20, a gas outlet 22 connected to a gas line 24, a first liquid water inlet 26 connected to a first water recovery line 28, a second liquid water inlet 30 connected to a second water recovery line 32, and a cleaned tailings outlet 34 connected to tailings outlet lines 36 and 38 having pumps 40 and 42, respectively. The column 10 also has an internal distributor 44 and a series of vertically spaced, internal shed decks 46. The cooler condenser 50 has a gas inlet 52 connected to gas line 24, a gas outlet 54 connected to vent line 56, and a liquid outlet 58 connected to liquid line 60. The decanter 70 has a liquid inlet 72 connected to liquid line 60, an internal weir 74, a gas outlet 76 connected to vent line 56, and a recovered diluent outlet 78 connected to a diluent recovery line 80.

In operation of this embodiment of the DRU 1, BFTP tailings containing a diluent (such as naphtha) is fed through feed line 14 into column 10 via BFTP tailings inlet 12. Within column 10, the BFTP tailings are distributed through a plurality of openings formed in distributor 44 so as to be evenly distributed over the shed decks 46. Meanwhile, steam line 20 injects steam into column 10 via steam inlet 18. As the injected steam rises within the column 10 in countercurrent to the settling BFTP tailings, the steam volatizes the residual diluent and water from the BFTP tailings, thus at least partially cleaning the BFTP tailings. The cleaned tailings settle towards the bottom of column 10 where they may mix with additional water injected into the column 10 via second liquid water inlet 30. The cleaned tailings are discharged as bottoms from the column 10 via cleaned tailings outlet 34 into tailings outlet lines 36 and 38. The volatized diluent and water rise towards the top of the column 10 where they are vented through gas outlet 22 into gas line 24, and into the cooler condenser 50 via gas inlet 52. The cooler condenser 50 converts the majority of volatized diluent and steam into liquid form, while allowing incondensable gases to vent via gas outlet 54 to vent line 56. The liquid diluent and water are discharged via liquid outlet 58 into decanter 70 via liquid inlet 72. Within the decanter 70, gas may be allowed to vent through gas outlet 76 into vent line 56. The denser liquid water settles in the bottom of decanter 70, and is discharged into first liquid recovery line 28 for return to the column 10 via first liquid water inlet 26. Alternatively, the liquid water from the decanter 70 can be mixed with additional water and recycled to the column 10 via second liquid water inlet 30. Within the decanter 70, weir 74 separates the liquid diluent from the water. The separated liquid diluent is discharged via recovered diluent outlet 78 into diluent recovery line 80, for re-use in the BFTP.

During the operation of the DRU 1, a variety of operating conditions can be monitored using suitable sensor means (not shown) known in the art (e.g., electromechanical flow sensors, electrochemical sensors, potentiometric sensors) and directly or indirectly controlled using suitable control means known in the art (e.g., pumps, valve systems, heating devices). For example, the volumetric flow rate, V_{F}, of the BFTP tailings injected into column 10 may be controlled by pump 16 or a valve system. The mass flow rate of steam, mₛ, injected into column 10 may be controlled by a pump, or a valve system. These and other operating conditions, such as the temperature of the BFTP tailings, the temperature and rate of water injected into the column via first liquid water inlet 26 and a second liquid water inlet 30, the venting rate of volatized diluent and water from gas outlet 22, may all affect the operating temperature, Tₒₚ, and operating pressure, Pₒₚ, of the volatized diluent and water at the top of the column 10. Ultimately, these operating conditions may affect the concentration of diluent in the cleaned tailings outlet, X_{DB}, and hence, the diluent recovery of the DRU 1.

In practice, these and other operating conditions may change during the operation of the DRU 1, and interact with each other to produce higher order effects on the diluent recovery of the DRU. Therefore, predicting the performance of the DRU 1 and making appropriate adjustments to the DRU 1 for optimal performance is a complex, multi-variable problem. A solution to the problem, suitable for industrial application, practically requires the use of a computer to provide output in a timely manner, and preferably, in real-time to react to changes in operating conditions.

Thus, in one aspect, the present invention provides a computer adapted to optimize the diluent recovery of the DRU 1. In general, system comprises a computer 100 that comprises a processor and a memory storing a set of instructions which are executed by the processor to perform the method of the present invention. The computer 100 may be a general purpose computer specifically adapted with the stored set of instructions, a special purpose computer, a microcomputer, an integrated circuit, a programmable logic device or any other type of computing technology known in the art that is capable of performing the method of the present invention. The memory may comprise any medium capable of storing instructions readable by a processor. It will be understood that in FIG. 1, the dashed arrow line connecting the DRU 1 and the computer 100, represents an operative connection, which may be a wired connection, a wireless connection, or a combination of wired and wireless connections. Further, it will be understood that the computer 100 may be a plurality of physically discrete components located at remote locations. For example, in the embodiment shown in FIG. 1, the computer 100 includes a desktop computer having a processor, a memory, and buses associated with the processor to operatively connect the processor to the memory, one or more sensor means, and one or more control means associated with the DRU 1. The desktop computer may be situated remotely from the DRU 1 and operatively connected to the DRU 1 through a communications network such as an intranet or the Internet, or a combination of an intranet and the Internet.

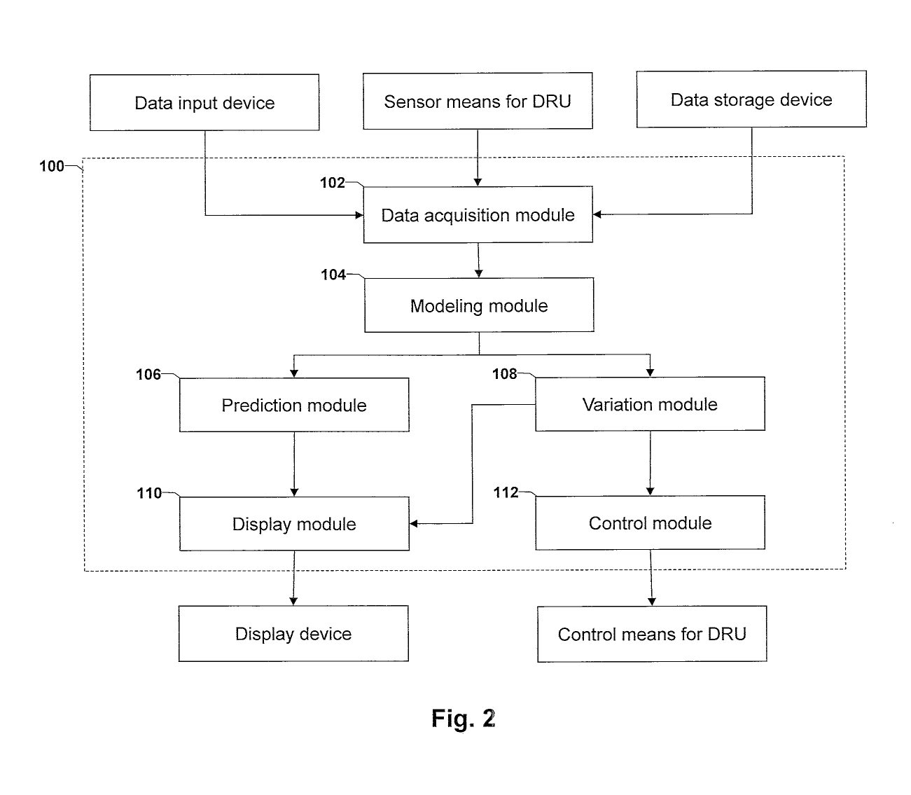

FIG. 2 shows a functional block diagram of an embodiment of a computer 100 used in the present invention. It will be understood that each functional block may be implemented by hardware, software, or a combination of hardware and software of the processor and the set of instructions stored on the memory. The data acquisition module 102 connects the computer 100 to an input device to control the acquisition and storage of data pertaining to the operating conditions and diluent recovery of the DRU 1. In embodiments, the data acquisition module 102 interfaces with a data entry device such as a keyboard of the computer 100, a data storage device such as memory of the computer 100, or the sensor means associated with the DRU 1. The modelling module 104 performs a regression analysis of the data acquired by the data acquisition module 102 to determine a regression model between the operating conditions of the DRU and the diluent recovery of the DRU. The prediction module 106 applies the regression model determined by the modelling module 104 to predict diluent recovery of the DRU for a given set of operating conditions. The variation module 108 applies the regression model determined by the modeling module 104 to determine a recommended value of one or more of the operating conditions of the DRU that is predicted to achieve a target diluent recovery (TDR). The display module 110 interfaces with a display device to generate graphical representations of information operated on and generated by the data acquisition model 102, modelling module 104, prediction module 106 and variation module 108 by a display device. In embodiments, the display device may comprise a monitor of the computer 100, a printer connected to the computer 100, or a human-readable file such as a spreadsheet. The control module 112 interfaces with and controls the control means associated with the DRU 1 to vary one or more of the operating conditions of the DRU 1 in accordance with information provided by the variation module 108.

The use and operation of the system of the present invention to implement an embodiment of a method of the present invention will now be described. To begin, the computer 100 receives and stores in its memory, a model data set, M, generated during operation of the DRU (step 300). The model data set comprises a plurality of data points for a plurality of operating conditions and a corresponding diluent recovery of the DRU 1, as measured or derived from the actual operation of the DRU 1. As such, the model data set comprises “real-life” data, and should exhibit variability in the values of at least one of the operating conditions and the diluent recovery. The data points of the model data set may be received through a system operator manually inputting the data using an input device, retrieved from a storage medium, or acquired directly in real-time from sensor means associated with the DRU 1. In one embodiment, each data point comprises information about the following operating conditions of the DRU 1: the concentration of diluent in the BFTP tailings, X_{DF}; the volumetric flow rate, V_{F}, of the BFTP tailings injected into the column 10; the mass flow rate of steam, mₛ, injected into column 10; the pressure, Pₒₚ, at the top of the column 10; the temperature, Tₒₚ, at the top of the column 10; the concentration of diluent in the cleaned tailings outlet, X_{DB}; and the diluent recovery, corresponding to aforementioned operating conditions. It will be understood that instead of the actual amount of diluent recovered, another parameter indicative of diluent recovery or loss by the DRU 1 may be used, such as a mass or volumetric quantity or rate of diluent loss or recovery.

It will be appreciated by those skilled in the art, that a model data set that comprises more data points and data points covering a larger range of operating conditions will tend to provide a more reliable and robust regression model than one with fewer data points, or data points that cover a smaller range of operating conditions. Once the model data set has been populated with a sufficient number of data points to provide a desired degree of reliability, a regression analysis is performed on the data points in the model data set to determine a regression model, F, of the relationship between the plurality of operating conditions and the corresponding diluent recovery of the DRU (step 310). The art of regression analysis will be understood by those persons of ordinary skill in the field of mathematical statistics as techniques for estimating the relationships amongst variables. In embodiments, regression analysis may comprise techniques for linear regression, non-linear regression, and multi-variable regression.

In one embodiment, the regression analysis used to determine the regression model between the operating conditions and the diluent recovery is based on four operating conditions (X_{DF}, V_{F}, Mₛ, and Pₒₚ). Based on a dimensional analysis, it was found that these operating conditions provided a strong correlation with diluent recovery data for a particular DRU (coefficient of determination, R² of ˜82% to ˜89% in a multi-variable regression analysis). These particular operational conditions are also amenable to being measured by sensor means and controlled by control means. In other embodiments, a fewer number, a greater number, or different operating conditions may be used in the regression analysis. In another embodiment, the regression model may be a constrained regression model with limits incorporated on selected variables based on process requirements or physical limits.

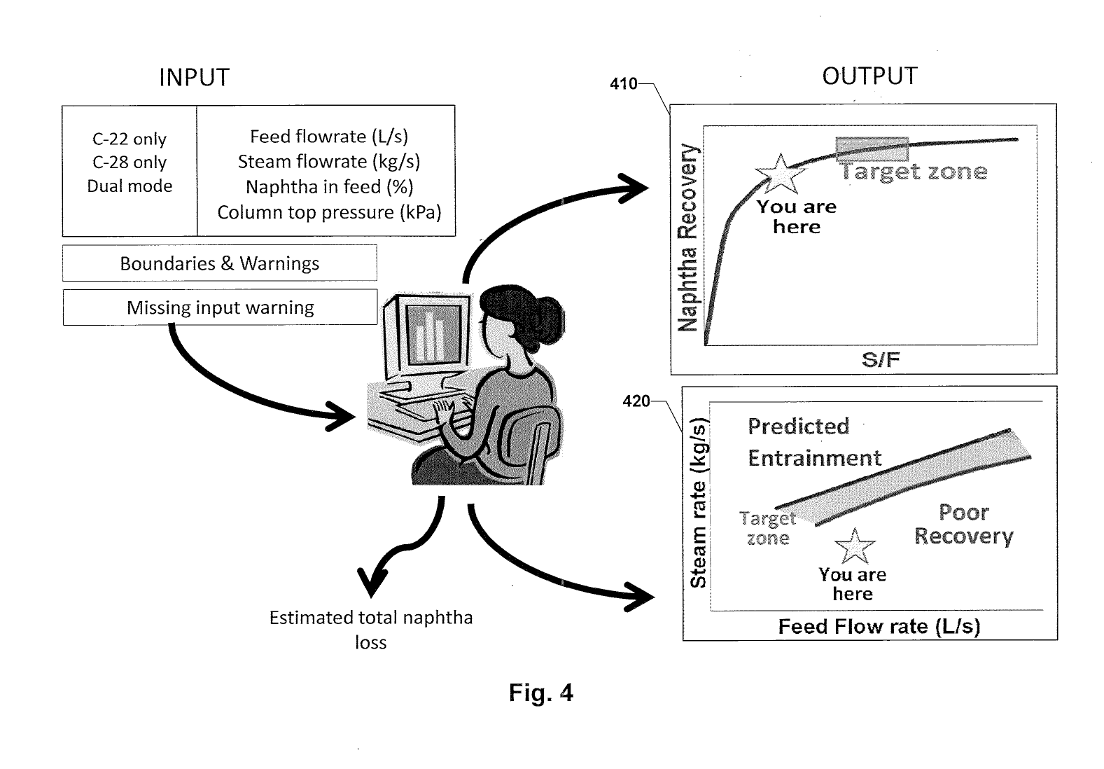

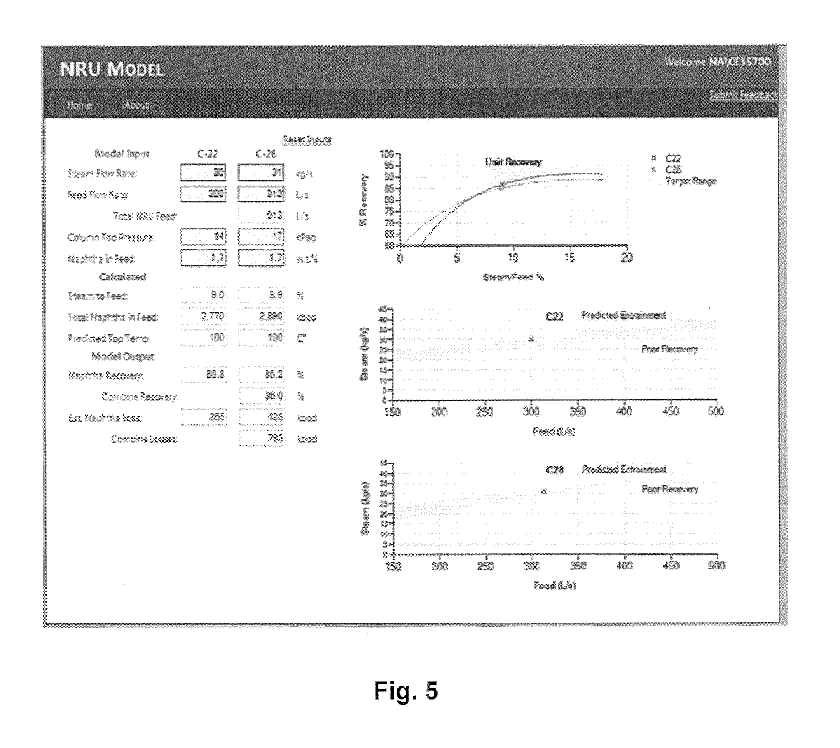

With the regression model, F, determined, the system is ready to receive an input data point representing a particular combination of actual or contemplated operating conditions (step 320). In embodiments as shown in FIGS. 4 and 5, for example, the system is implemented as desktop tool and provides an operator with a graphical user interface (GUI) adapted for a DRU 1 having two columns 10 (denoted C-22 and C-28). The GUI provides fields allowing the operator to input four operating conditions (X_{DF}, V_{F}, mₛ, and Pₒₚ) for each of the columns 10. In one embodiment, the GUI may provide the operator with a visual or audible warning if any of the operating conditions is missing or outside of a specified range such as a design limit. In other embodiments, the system may automatically receive the input data point directly in real-time from a sensor means associated with the DRU 1, without the need for operator intervention. The input data point may be received from the sensor means at discrete time intervals or continuously.

In response to receiving the input data point, the regression model operates on the input data point to predict the diluent recovery (step 330) within process or physical constraints as applicable. In other embodiments, the regression model may predict another parameter indicative of the recovery or loss of diluent by the DRU 1, such as the concentration of diluent in the cleaned tailings outlet, X_{DB}. In embodiments, the system may further apply the regression model or other rational models to predict other operating conditions such as the top operating temperature of the column, Tₒₚ, or outcomes such the mass or volumetric rate of diluent recovery or loss by the DRU 1.

The system compares the predicted diluent recovery to a specified target diluent recovery (TDR) (step 340). For example, the specified TDR range may be selected to be between 80 and 90 percent in order to meet regulations governing the discharge of diluent into tailings ponds, while managing operational demands on the DRU 1. In one embodiment, the system may allow an operator to save or automatically save recommended operating conditions as preset scenarios, which may be subsequently manually selected by an operator or automatically selected by the system.

If the system determines that the predicted diluent recovery is outside the TDR range, then the system applies the regression model to determine a recommended variation in one or more of the operating conditions of the DRU 1 to achieve the TDR range (step 350).

In one non-limiting example, the system may determine that the input data point's ratio of the mass flow rate of steam, mₛ, to the volumetric flow rate, V_{F}, of the BFTP tailings into the column 10, is too low to achieve the TDR range. By applying the regression model, the system may determine that an increase mass flow rate of steam,Δmₛ, is needed to achieve the TDR range, assuming that the volumetric flow rate, V_{F}, remains constant.

In another non-limiting example, one embodiment of the DRU 1 may have a bifurcated feed line 14 that feeds BFTP tailings into two stripping columns 10. The system may determine that the diluent recovery of the first stripping column 10 is less than the TDR range, while the diluent recovery of the second stripping column 10 is within or greater than the TDR range. By applying the regression model, the system distribution of BFTP tailings into the two columns 10 can be rebalanced by decreasing the volumetric flow rate, V_{F}, of the BFTP tailings into the first column 10, and increasing the volumetric flow rate, V_{F}, of the BFTP tailings into the second column 10, such that diluent recovery for both columns 10 is within the TDR range.

The system causes the display device to generate a graphical representation of either the regression model in association with one or more of the input data point, the predicted diluent recovery, or the recommended value of one or more of the operating conditions of the DRU 1 (step 350). In embodiments as shown in FIGS. 4 and 5, for example, the GUI has fields allowing for output of information derived from the input data point, such as the ratio of the mass flow rate of steam, mₛ, to the volumetric flow rate, V_{F}, of the BFTP tailings into each of the columns 10 (in FIG. 5, labeled “Steam to Feed”), the volumetric flow rate of diluent into each of the columns 10 (in FIG. 5, labeled “Total Naphtha in Feed”), and the predicted top temperature of each of the columns 10. Further, the GUI has fields allowing for output of information predicted from the regression model. These include the diluent recovery of each column 10 and the columns 10 in combination (in FIG. 5, labeled as “Naphtha Recovery”), and estimated diluent losses (in FIG. 5, labeled as “Est. Naphtha Loss”).

In embodiments, the GUI may provide the information in chart form. In embodiments as shown in FIGS. 4 and 5, for example, the GUI displays two types of charts. The first type of chart 410 compares the diluent recovery of the DRU 1 to the “Steam to Feed” ratio. The chart includes a shaded region showing the TDR range, two curved lines corresponding to the regression model for each of the columns 10, and two data points corresponding to the input data point of operating conditions for each of the columns 10. The second type of chart 420 compares the ratio of the mass flow rate of steam, mₛ, to the volumetric flow rate, V_{F}, of the BFTP tailings. The chart includes a shaded region showing combinations of these operating conditions that are predicted by the regression model to allow the DRU 1 to achieve a diluent recovery within a target diluent recovery (TDR) range, while constraining operation to regimes that can cause operational problems. A data point corresponding to the input data point of the operating conditions is also shown.

In embodiments, the GUI may also provide a visible or audible alert or a warning to the operator if any of input operating conditions, the recommended variation in operating conditions, or the predicted diluent recovery of the DRU 1 is outside of a specified range, such as a design limit.

In addition or in the alternative, the system may cause a control means to vary at least one of the plurality of operating conditions in accordance with the recommended variation in the operating condition (step 380). The variation may be made in real-time, in the sense that the variation is, for all practical purposes, responsive to the operating conditions prevailing at the time that the input data point was received by the system.

To the extent that the regression model is non-linear, it will be understood that the variation in one or more of the operating conditions in accordance with the recommended variation may result in a diluent recovery that is different from the predicted diluent recovery. Accordingly, the system may receive an additional data point for the plurality of operating conditions and the corresponding diluent recovery of the DRU (step 380). This data point may be added to the existing model data set to improve its correlation to the diluent recovery, thus providing “feedback” from the DRU 1 to the system to self-train the system. The preceding steps 320-380 may then be performed iteratively, as necessary (step 390), until the difference between the actual diluent recovery and the target diluent recovery is acceptably small.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

We claim:

1. A method for optimizing diluent recovery of a diluent recovery unit (DRU) used to recover a diluent from a tailings generated by a bitumen froth treatment process (BFTP), the method executed by a processor operatively connected to a memory storing a set of instructions, the method comprising the steps of:
(a) receiving and storing in the memory, a model data set generated during operation of the DRU, wherein the model data set comprises a plurality of data points for a plurality of operating conditions and a corresponding diluent recovery of the DRU, wherein at least one of the plurality of operating conditions exhibits variation over a range of values;
(b) based on the model data set, determining a regression model of a relationship between the plurality of operating conditions and the corresponding diluent recovery of the DRU;
(c) receiving an input data point for the plurality of operating conditions, and in response thereto, taking a related action comprising the steps of:
(i) predicting the diluent recovery of the DRU, based on the regression model; and
(ii) causing a display device to display a representation of the regression model in association with the input data point, and the predicted diluent recovery of the DRU.

2. A method for optimizing diluent recovery of a diluent recovery unit (DRU) used to recover a diluent from a tailings generated by a bitumen froth treatment process (BFTP), the method executed by a processor operatively connected to a memory storing a set of instructions, the method comprising the steps of:
(a) receiving and storing in the memory, a model data set generated during operation of the DRU, wherein the model data set comprises a plurality of data points for a plurality of operating conditions and a corresponding diluent recovery of the DRU, wherein at least one of the plurality of operating conditions exhibits variation over a range of values;
(b) based on the model data set, determining a regression model of a relationship between the plurality of operating conditions and the corresponding diluent recovery of the DRU;
(c) receiving an input data point for the plurality of operating conditions, and in response thereto, taking a related action comprising the steps of:
(i) predicting the diluent recovery of the DRU, based on the regression model;
(ii) determining a recommended value for at least one of the plurality of operating conditions for the predicted diluent recovery to approach a target diluent recovery, based on the regression model; and
(iii) causing the display device to display a representation of the recommended value for the at least one of the plurality of operating conditions.

3. A method for optimizing diluent recovery of a diluent recovery unit (DRU) used to recover a diluent from a tailings generated by a bitumen froth treatment process (BFTP), the method executed by a processor operatively connected to a memory storing a set of instructions, the method comprising the steps of:
(a) receiving and storing in the memory, a model data set generated during operation of the DRU, wherein the model data set comprises a plurality of data points for a plurality of operating conditions and a corresponding diluent recovery of the DRU, wherein at least one of the plurality of operating conditions exhibits variation over a range of values;
(b) based on the model data set, determining a regression model of a relationship between the plurality of operating conditions and the corresponding diluent recovery of the DRU;
(c) receiving an input data point for the plurality of operating conditions, and in response thereto, taking a related action comprising the steps of:
(i) predicting the diluent recovery of the DRU, based on the regression model;
(ii) determining a recommended value for at least one of the plurality of operating conditions for the predicted diluent recovery to approach a target diluent recovery, based on the regression model; and
(iii) causing a control means associated with the DRU to vary the at least one of the plurality of operating conditions towards the recommended value.

4. The method of claim 3 wherein the at least one related action comprises the further steps, after step (c)(ii) of claim 3, of:
(a) receiving a new data point for the plurality of operating conditions and a corresponding diluent recovery of the DRU; and
(b) updating the model data set by storing the new data point as one of the data points of the model data set.
(c) based on the updated model data set, re-determining the regression model;
(d) performing step (c)(i) and (iii) of claim 3 using the re-determined regression model in place of the regression model.

5. The method of claim 4 wherein steps (a) to (c) are performed iteratively until the difference between the predicted diluent recovery and the target diluent recovery is below a desired value.

6. The method of claim 1 wherein the DRU comprises a stripping column, and the plurality of operating conditions comprises: a flow rate of the tailings into the stripping column; a concentration of the diluent in the tailings flowing into the stripping column; a flow rate of steam into the stripping column; and a top pressure of the stripping column.

7. The method of claim 1 wherein the DRU comprises a first stripping column and a second stripping column, and the plurality of operating conditions comprises a first flow rate of the tailings into the first stripping column and a second flow rate of the tailings into the second stripping column.

8. The method of claim 7 wherein the plurality of operating conditions further comprises a concentration of the diluent in the tailings flowing into the first and second stripping columns; a flow rate of steam into the first and second stripping columns; and a top pressure of the first and second stripping columns.

9. A system for optimizing diluent recovery of a diluent unit (DRU) used to recovery a diluent from a tailings generated by a bitumen froth treatment process (BFTP), the system comprising:
(a) a processor; and
(b) a memory storing a set of instructions executable by the processor to implement a method as claimed in claim 1.

10. A diluent recovery unit (DRU) used to recover a diluent from a tailings generated from a bitumen froth treatment process (BFTP), the DRU comprising:
(a) a DRU comprising a stripping column;
(b) a sensor means for measuring a plurality of operating conditions associated with the stripping column and a diluent recovery rate of the DRU;
(c) a control means for controlling at least one of the plurality of operating conditions;
(d) a computer comprising a processor and a memory storing a set of instructions;
wherein the processor is operatively connected to the sensor means to receive a signal indicative of the plurality of operating conditions and the corresponding diluent recovery of the DRU;
wherein the processor is operatively connected to the control means to cause the control means to vary at least one of the plurality of operating conditions of the DRU; and
wherein the processor is responsive to the set of instructions to implement a method as claimed in claim 1.

11. A computer program product comprising a medium storing instructions readable by a processor to cause the processor to execute a method as claimed in claim 1.
